(19) United States
(12) Patent Application Publication
(10) Pub. No.: US 2023/0191602 A1
(43) Pub. Date: Jun. 22, 2023

(54) PROCESSING TOOL MASTERING METHOD

(71) Applicant: FANUC CORPORATION, Yamanashi (JP)

(72) Inventors: Masao MOTOHASHI, Yamanashi (JP); Kentarou YANAGIHARA, Yamanashi (JP)

(73) Assignee: FANUC CORPORATION, Yamanashi (JP)

(21) Appl. No.: 17/758,872

(22) PCT Filed: Apr. 22, 2021
(86) PCT No.: PCT/JP2021/016279

§ 371 Date: Jan. 20, 2023

(30) Foreign Application Priority Data
Apr. 27, 2020 (JP) 2020-078311

(51) Int. Cl. B25J 9/16

(52) U.S. Cl. CPC B25J 9/1664; B25J 9/1653

(57) ABSTRACT

Provided is a mastering method that can be easily carried out with respect to a processing tool mounted to an arm tip portion of a robot having a driving shaft. The present invention provides a processing tool mastering method for mastering a processing tool by: controlling a driving unit of a multi-joint robot which carries, at an arm tip portion, a processing tool for performing a predetermined process on a workpiece and which is provided with a plurality of driving units for driving one or a plurality of driving shafts; and controlling a processing position of the processing tool with respect to the workpiece. The mastering method comprises obtaining, from the movement of the robot, reference direction information which is information pertaining to a reference direction of the robot, and carrying out mastering of the processing tool on the basis of the reference direction information thus obtained.

### TECHNICAL FIELD

The present invention relates to a processing tool mastering method for performing mastering of processing tools configured to perform various kinds of processes such as gripping and machining.

### BACKGROUND ART

For an industrial robot, at a final stage of a manufacturing process, at the time of performing adjustment for shipment to a user, at the time of exchanging a servomotor as an example of a drive source of a robot, or at the time of restoration after an interference accident has occurred during operation of a robot system, calibration for making an origin posture of an actual robot and an origin of a program related to the robot coincident with each other, that is, mastering is performed (see, for example, Patent Document 1 below). Such a mastering task is also similarly performed on a processing tool that is mounted on a distal end part of an arm of a robot and controls a processing position for the processing tool to perform a process on a processing target by driving one or more (rotational) driving axes included in the processing tool itself.

As an example of such a processing tool, there is an articulated hand arm including two links and attachable to a distal end part of an arm of a robot. In the mastering task, adjustment is performed using a mark attached to the hand arm and a dedicated jig.

### PRIOR ART DOCUMENTS

### Patent Documents

Patent Document 1: Japanese Unexamined Patent Application, Publication No. H08-171410

### SUMMARY OF THE INVENTION

### Problems to be Solved by the Invention

When a hand arm does not have a mark, however, a problem occurs that a re-mastering task requires much time and effort in an environment where dedicated equipment is not provided at the time of maintenance after shipment. The same applied to a case where there is not a dedicated jig. Further, in general, it is necessary to provide settings such that a reference direction of a robot and a reference direction of a processing tool are aligned with each other. In a case where the robot does not have any mark, it will take much time and effort to perform mastering so that both reference directions coincide with each other. Therefore, there is a demand for a mastering method that can be easily carried out on a processing tool mounted on a distal end part of an arm of a robot having driving axes.

### Means for Solving the Problems

The present disclosure relates to a processing tool mastering method for performing mastering of a processing tool that is attached to an arm distal end part of an articulated robot and is configured to perform a predetermined process on a processing target, the articulated robot including a plurality of driving units configured to drive one or more driving axes of the articulated robot. The processing tool mastering method includes: controlling the plurality of driving units; controlling a processing position for the processing tool to perform the process on the processing target; and obtaining, from a movement of the robot, reference direction information about a reference direction of the robot, so that the mastering of the processing tool is performed based on the obtained reference direction information.

### Effects of the Invention

The present disclosure provides a mastering method that can be easily carried out for a processing tool mounted on an arm distal end part of a robot having driving axes.

### BRIEF DESCRIPTION OF THE DRAWINGS

FIG. 1 is a diagram showing a system configuration of a robot system of a first application example to which the present invention is applied;

FIG. 2A is a side view of the robot system of the first application example;

FIG. 2B is a partially enlarged plan view of the robot system of the first application example;

FIG. 3A is a side view showing one step of a mastering task for the robot system of the first application example (a diagram corresponding to FIG. 2A);

FIG. 3B is a partially enlarged plan view corresponding to FIG. 3A (a diagram corresponding to FIG. 2B);

FIG. 4A is a side view showing a step subsequent to the step shown in FIG. 3A;

FIG. 4B is a partially enlarged plan view corresponding to FIG. 4A;

FIG. 5A is a side view showing a step subsequent to the step shown in FIG. 4A;

FIG. 5B is a partially enlarged plan view corresponding to FIG. 5A;

FIG. 6A is a side view showing a step subsequent to the step shown in FIG. 5A;

FIG. 6B is a partially enlarged plan view corresponding to FIG. 6A;

FIG. 7A is a side view showing a step subsequent to the step shown in FIG. 6A;

FIG. 7B is a partially enlarged plan view corresponding to FIG. 7A;

FIG. 8 is a diagram illustrating a principle of a rotary wedge scanner according to a second application example to which the present invention is applied;

FIG. 9A is a side view showing one step of a mastering task for a robot system of the second application example;

FIG. 9B is a partially enlarged plan view corresponding to FIG. 9A;

FIG. 10A is a side view showing a step subsequent to the step shown in FIG. 9A;

FIG. 10B is a partially enlarged plan view corresponding to FIG. 10A;

FIG. 11A is a side view showing a step subsequent to the step shown in FIG. 10A;

FIG. 11B is a partially enlarged plan view corresponding to FIG. 11A; and

FIG. 12 is a diagram illustrating a principle of a Galvano scanner according to a third application example to which the present invention is applied.

### PREFERRED MODE FOR CARRYING OUT THE INVENTION

### First Application Example

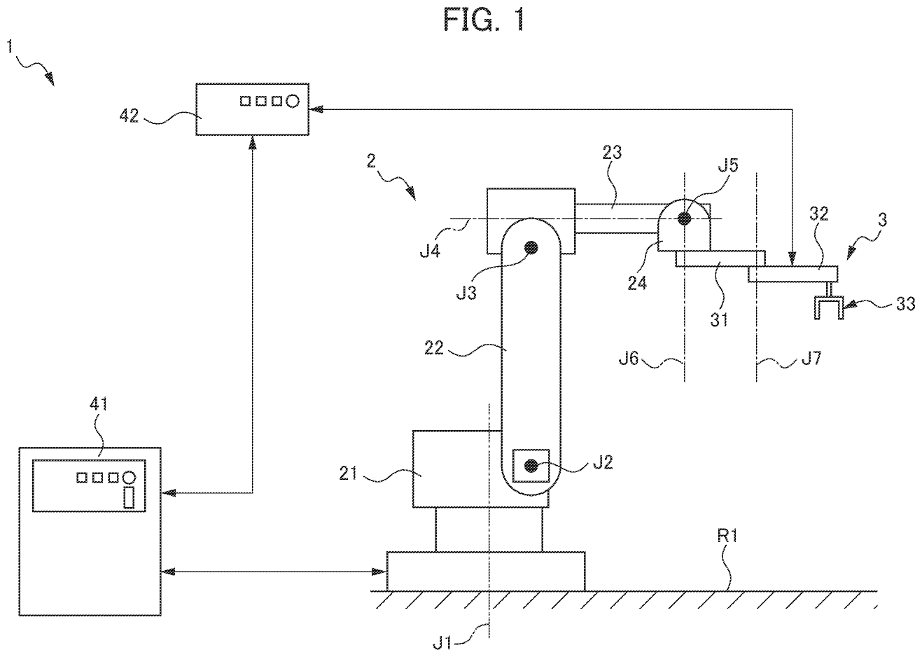

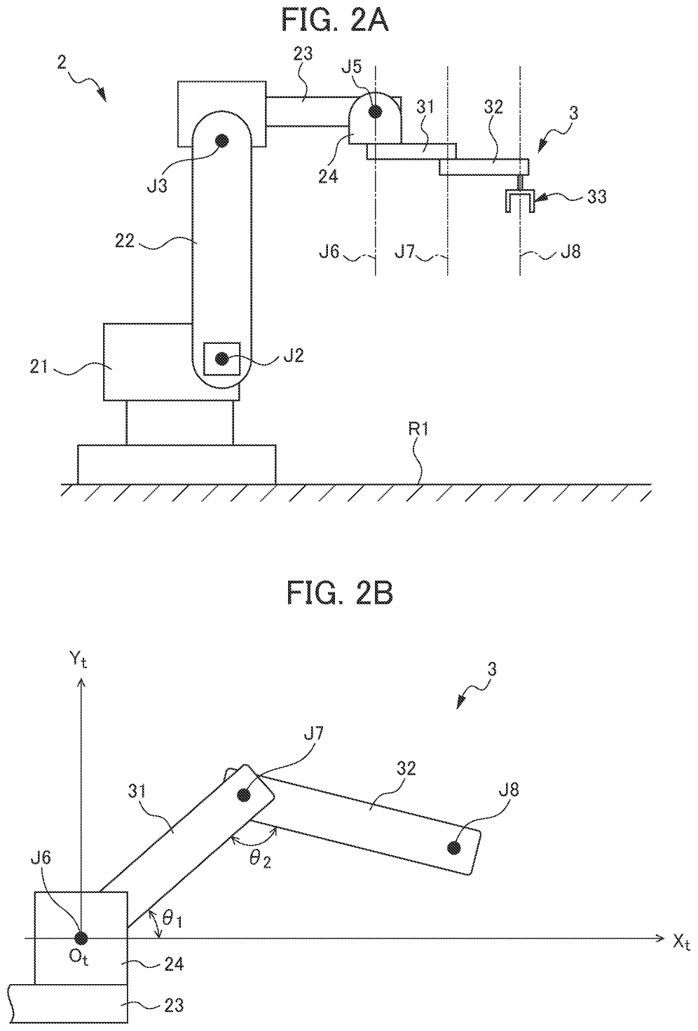

A first application example will be described below with reference to accompanying drawings. The first application example is an example in which a processing tool mastering method of the present invention is applied to a robot system including a robot and a hand arm. In the drawings, the same or corresponding portions are denoted by the same reference signs. FIG. 1 is a diagram showing a system configuration of the robot system of the first application example to which the present invention is applied. FIG. 2A is a side view of the robot system of the first application example. FIG. 2B is a partially enlarged plan view of the robot system of the first application example.

As shown in FIGS. 1 to 2B, a robot system 1 of the first application example includes a robot 2, a hand arm 3 that is an example of a processing tool, a robot controller 41 that controls the robot 2, and a tool controller 42 that controls the hand arm 3. The robot system 1 moves the robot 2 and the hand arm 3 to a target position and causes the hand arm 3 to perform a predetermined process on a workpiece (not shown).

In the first application example, the process refers to gripping the workpiece or the like (e.g., holding the workpiece from two sides or by a force of attraction), but is not limited thereto. The process may be contact removal machining (e.g., cutting, welding, etc.), non-contact removal machining (e.g., laser machining, etc.) or discharging a fluid (e.g., a sealing material, a paint, etc.).

The robot 2 is, for example, a 6-axis vertical articulated robot and has a base 21, a lower robot arm 22, an upper robot arm 23, and a robot arm distal end part 24 (an arm distal end part). The base 21 is installed on a reference plane R1 that is a floor surface. One end of the lower robot arm 22 is coupled to the base 21 such that the lower robot arm 22 is rotatable around a first axis (a vertical axis) J1 and a second axis (a horizontal axis) J2. The other end of the lower robot arm 22 is coupled to one end of the upper robot arm 23 such that the upper robot arm 23 is rotatable around a third axis (a horizontal axis) J3. The other end of the upper robot arm 23 is coupled to the robot arm distal end part 24 such that the robot arm distal end part 24 is rotatable around a fourth axis J4 perpendicular to the third axis J3 and rotatable around a fifth axis J5 perpendicular to the fourth axis J4. The robot arm distal end part 24 has the hand arm 3, which is an example of a processing tool, attached thereto such that the hand arm 3 is rotatable around a sixth axis J6 perpendicular to the fifth axis J5.

The robot 2 is not limited to the 6-axis vertical articulated type but may be another type of articulated robot such as a 4-axis vertical articulated robot. The number of driving axes may be one.

The robot 2 incorporates a plurality of servomotors (not shown) that drive the plurality of driving axes including the first to sixth axes J1 to J6, respectively. The servomotors are driven according to control signals from the robot controller 41. Driving the servomotors allows the position and posture of the robot 2 to be changed and the position and posture of the hand arm 3 attached to the robot 2 to be changed.

The hand arm 3 is an example of the processing tool. A processing tool performs a predetermined process on a processing target while a processing position for the processing tool to perform the process on the processing target is controlled. Each of the processing target and the processing position differs depending on the content of the process. When the measure is gripping, the processing target is an object to be gripped, and the processing position is a position at which the object is to be gripped. When the process is machining, the processing target is an object to be machined, and the processing position is a position at which the object is to be machined. When the process is discharging, the processing target is an application target (for example, a member to which a sealing material is to be applied), and the processing position is a position at which the application is implemented.

The hand arm 3 is held at the robot arm distal end part 24. The hand arm 3 is, for example, a uniaxial articulated arm mechanism and has a first hand arm 31, a second hand arm 32, and a gripper 33. One end of the first hand arm 31 is coupled to the robot arm distal end part 24 such that the first hand arm 31 is rotatable around the sixth axis J6. The other end of the first hand arm 31 is coupled to one end of the second hand arm 32 such that the second hand arm 32 is rotatable around a seventh axis J7. The other end of the second hand arm 32 is coupled to the gripper 33 that grips a workpiece or the like. A reference axis of the gripper 33 is referred to as an eighth axis J8 (see FIG. 2A). The sixth axis J6, the seventh axis J7, and the eighth axis J8 are arranged in parallel. The gripper 33 grips the workpiece by any method, such as holding the workpiece from two sides or with a force of attraction, or suctioning the workpiece.

The hand arm 3 incorporates a servomotor (not shown) that drives the driving axis of the seventh axis J7. The servomotor is driven according to a control signal from the tool controller 42. Driving the servomotor allows the position and posture of the gripper 33 of the hand arm 3 to be changed and a gripping operation to be performed.

Each of the robot controller 41 and the tool controller 42 includes an arithmetic processer having a CPU, a ROM, a RAM, other peripheral circuits, and the like. The robot controller 41 and the tool controller 42 mutually perform signal transmission/reception (communication). The robot controller 41 stores operation programs (task programs) for the robot 2 and the processing tool, teaching data, and the like. The robot controller 41 may also serve as the tool controller 42.

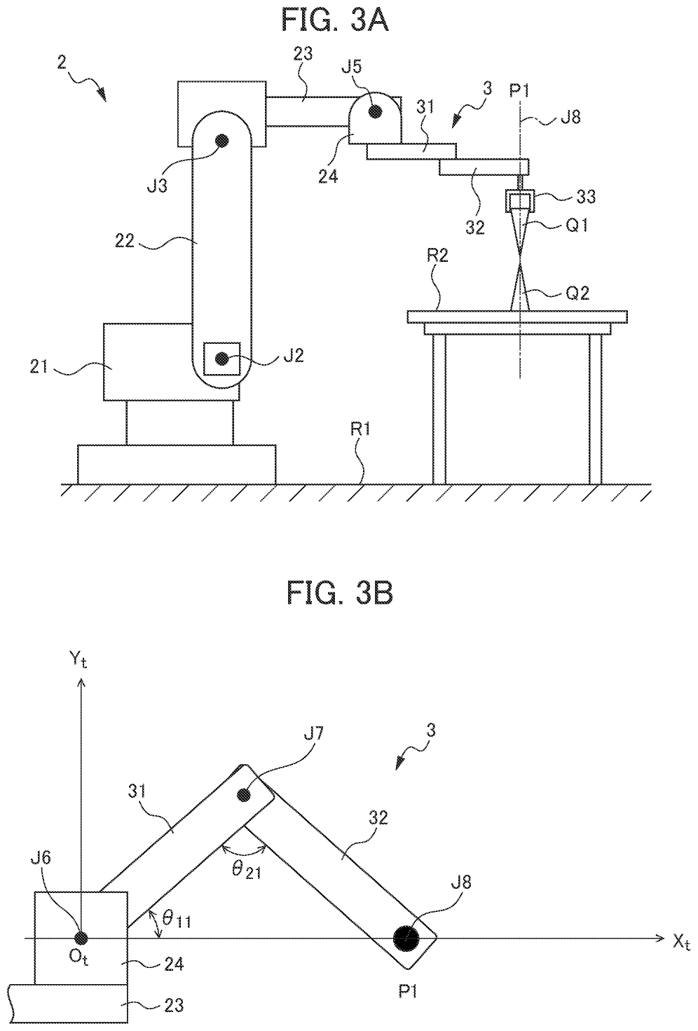

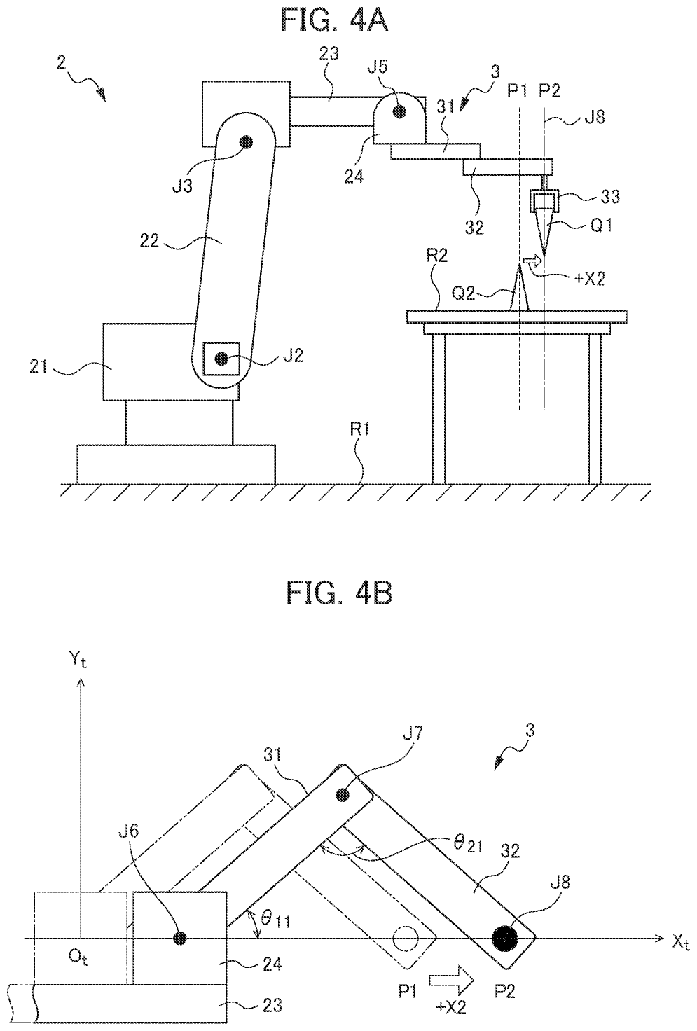

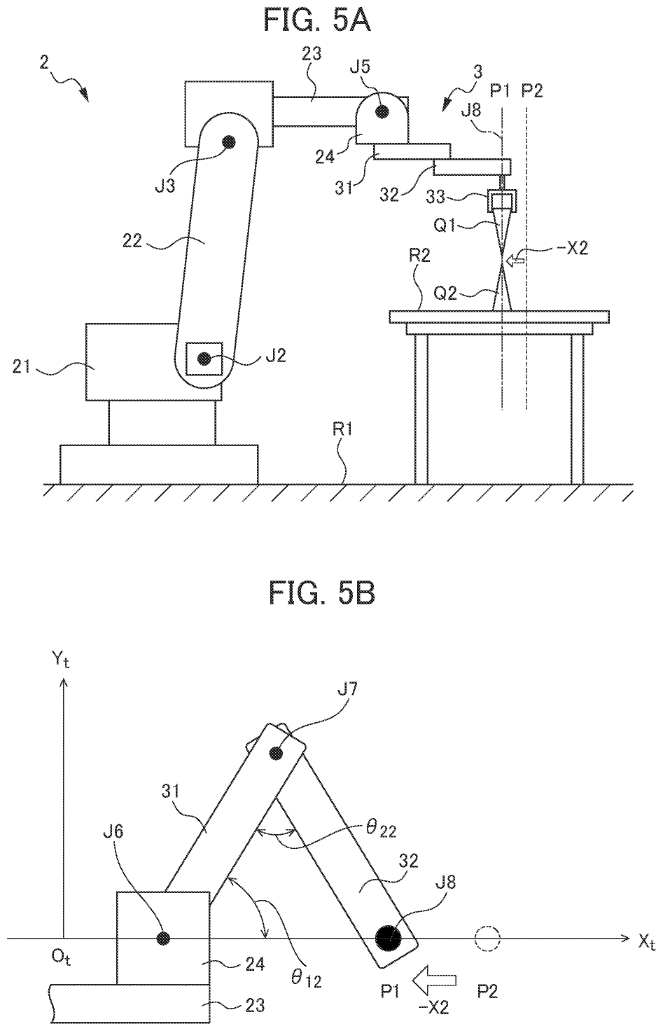

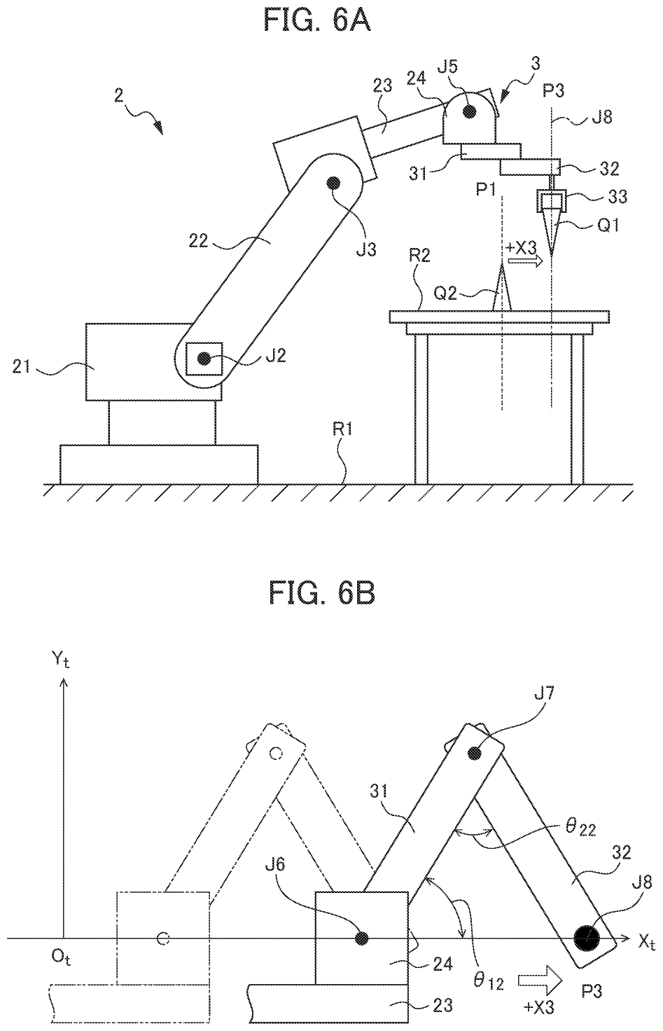

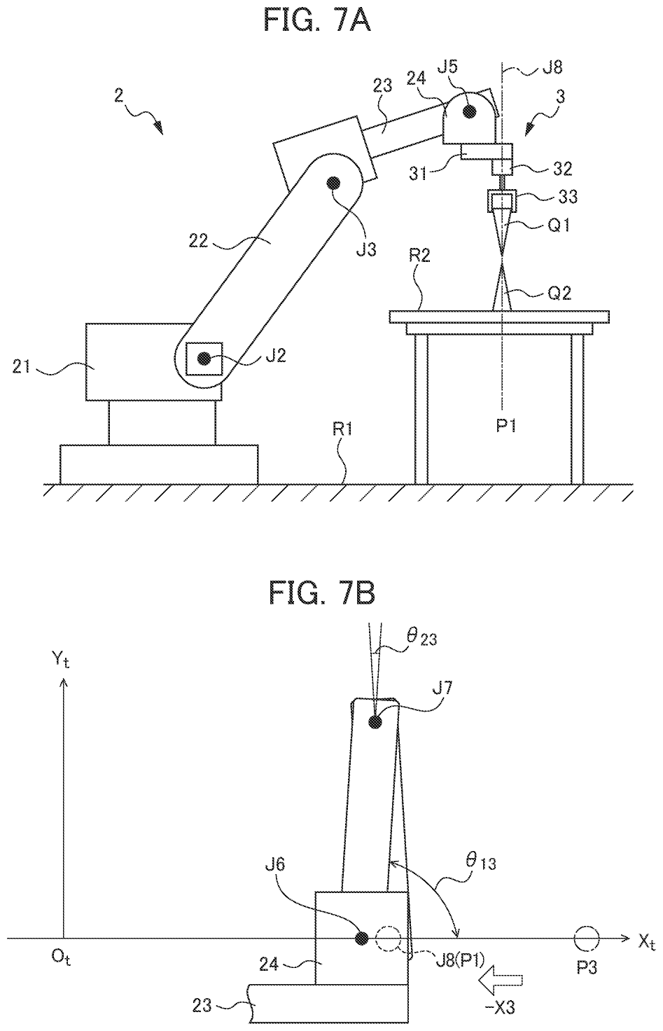

A mastering task for the robot system of the first application example will be described with reference to FIGS. 2A to 7B. FIG. 3A is a side view showing one step of the mastering task for the robot system of the first application example (a diagram corresponding to FIG. 2A). FIG. 3B is a partially enlarged plan view corresponding to FIG. 3A (a diagram corresponding to FIG. 2B). FIG. 4A is a side view showing a step subsequent to the step shown FIG. 3A. FIG. 4B is a partially enlarged plan view corresponding to FIG. 4A. FIG. 5A is a side view showing a step subsequent to the step shown FIG. 4A. FIG. 5B is a partially enlarged plan view corresponding to FIG. 5A. FIG. 6A is a side view showing a step subsequent to the step shown FIG. 5A. FIG. 6B is a partially enlarged plan view corresponding to FIG. 6A. FIG. 7A is a side view showing a step subsequent to the step shown FIG. 6A. FIG. 7B is a partially enlarged plan view corresponding to FIG. 7A.

As shown in FIGS. 2A and 2B, the position and posture of the robot 2 are changed so that the seventh axis J7 that is a final driving axis of the robot system 1 (the robot 2 equipped with the hand arm 3) becomes vertical relative to reference plane R1 of the base 21 of the robot 2. When the seventh axis J7 becomes vertical relative to the reference plane R1, the sixth axis J6 and the eighth axis J8 also become vertical relative to the reference plane R1 consequently. As a reference Cartesian coordinate system for the robot, an Xt-Yt coordinate system (origin: Ot) is set. The reference plane R1 is parallel to the Xt-Yt plane. An angle formed between the Xt axis and a longitudinal direction of the first hand arm 31 is referred to as θ1. An angle formed between the longitudinal direction of the first hand arm 31 and a longitudinal direction of the second hand arm 32 is referred to as θ2.

As shown in FIGS. 3A and 3B, the gripper 33 of the hand arm 3 is caused to grip an apparatus-side pin Q1. The tip of the apparatus-side pin Q1 is oriented to the reference plane R1. On the reference plane R1, a table having a second reference plane R2 parallel to the reference plane R1 is placed. On the second reference plane R2, a target pin Q2 paired with the apparatus-side pin Q1 is placed. The tip of the target pin Q2 is oriented opposite to the reference plane R1. A position of the tip of the target pin Q2 projected to the reference plane R1 (the second reference plane R2) is referred to as “a position P1”.

A position J8 of the gripper 33 of the hand arm 3 (which is also the position of the tip of the apparatus-side pin Q1 projected to the reference plane R1 (the second reference plane R2)) is moved to the position P1 so that the tip of the apparatus-side pin Q1 and the tip of the target pin Q2 are positioned opposite to and in alignment with each other. In this state, an angle formed between the Xt axis and the longitudinal direction of the first hand arm 31 is referred to as θ11, and an angle formed between the longitudinal direction of the first hand arm 31 and the longitudinal direction of the second hand arm 32 is referred to as θ21.

As shown in FIGS. 4A and 4B, the robot 2 is moved in a +Xt direction of the Cartesian coordinate system by a movement amount of +X2, while the posture of the hand arm 3 is maintained (while the angles θ11 and θ12 are maintained). In this state, a position of the tip of the apparatus-side pin Q1 projected to the reference plane R1 (the second reference plane R2) is stored as “a position P2”.

As shown in FIGS. 5A and 5B, the position J8 of the gripper 33 of the hand arm 3 is moved in a −Xt direction of the Cartesian coordinate system by a movement amount of −X2, while the posture and position of the robot 2 are maintained, so that the position J8 is moved to the position P1 of the tip of the apparatus-side pin Q1. Then, the tip (J8) of the apparatus-side pin Q1 and the tip of the target pin Q2 (P1) are positioned opposite to and in alignment with each other again. At that time, an angle θ12 formed between the Xt axis and the longitudinal direction of the first hand arm 31 is larger than the angle θ11 (θ12>θ11), and an angle θ22 formed between the longitudinal direction of the first hand arm 31 and the longitudinal direction of the second hand arm 32 is smaller than the angle θ21 (θ22<θ21).

As shown in FIGS. 6A and 6B, the robot 2 is moved in the +Xt direction of the Cartesian coordinate system by a movement amount of +X3, while the posture of the hand arm 3 is maintained (while the angles θ21 and θ22 are maintained). In this state, a position of the tip of the apparatus-side pin Q1 projected to the reference plane R1 (the second reference plane R2) is stored as “a position P3”.

As shown in FIGS. 7A and 7B, the position J8 of the gripper 33 of the hand arm 3 is moved in the −Xt direction of the Cartesian coordinate system by a movement amount of −X3, while the posture and position of the robot 2 are maintained, so that the position J8 is moved to the position P1 of the tip of the apparatus-side pin Q1. Then, the tip (J8) of the apparatus-side pin Q1 and the tip of the target pin Q2 (P1) are positioned opposite to and in alignment with each other again. At that time, an angle θ13 formed between the Xt axis and the longitudinal direction of the first hand arm 31 is larger than the angle θ12 (θ13>θ12), and an angle θ23 formed between the longitudinal direction of the first hand arm 31 and the longitudinal direction of the second hand arm 32 is smaller than the angle θ22 (θ23<θ22).

From the movement amounts of the hand arm 3 with respect to the three positions P1, P2, and P3, an angle formed between a reference direction of the robot 2 and a reference direction of the hand arm 3 is calculated. Then, mastering is performed so that this angle becomes zero, that is, so that both reference directions coincide with each other. In short, reference direction information that is information about the reference direction of the robot 2 is obtained from a movement of the robot 2, and mastering of the hand arm 3 as an example of the processing tool is performed based on the obtained reference direction information.

The mastering of the present embodiment can be easily carried out with respect to the hand arm 3 that is a processing tool mounted on the robot arm distal end part 24 of the robot 2 having the driving axes. Thereby, time and effort required for operation confirmation after the mastering and those required for a correction task of the mastering are reduced, and efficiency of the mastering task can be improved. Especially, even when the hand arm 3 does not have a mark or even when there is not a dedicated jig, the mastering task can be easily performed. By disusing a mark or a dedicated jig, costs can be reduced.

### Second Application Example

Next, a second application example will be described. The second application example is an example in which the processing tool mastering method of the present invention is applied to a robot system including a robot and a rotary wedge scanner. The processing tool mastering method of the present invention is also applicable to a processing tool including a cutting head having an optical part that is capable of transmitting or reflecting a laser beam and rotating around a rotary axis and a condensing optical system that condenses the laser beam.

In the description of the second application example and subsequent description, the same components as those of the first application example will be denoted by the same reference signs, and description thereof will be omitted or simplified.

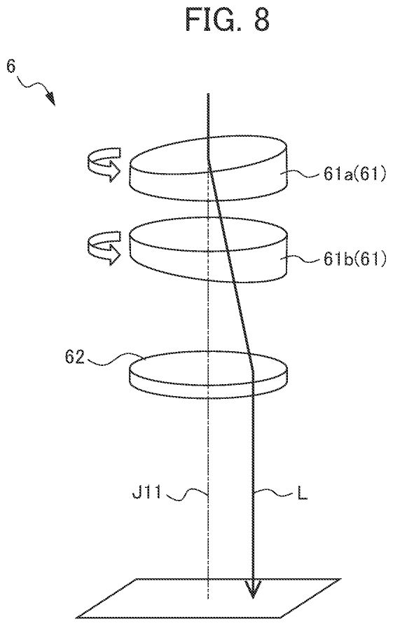

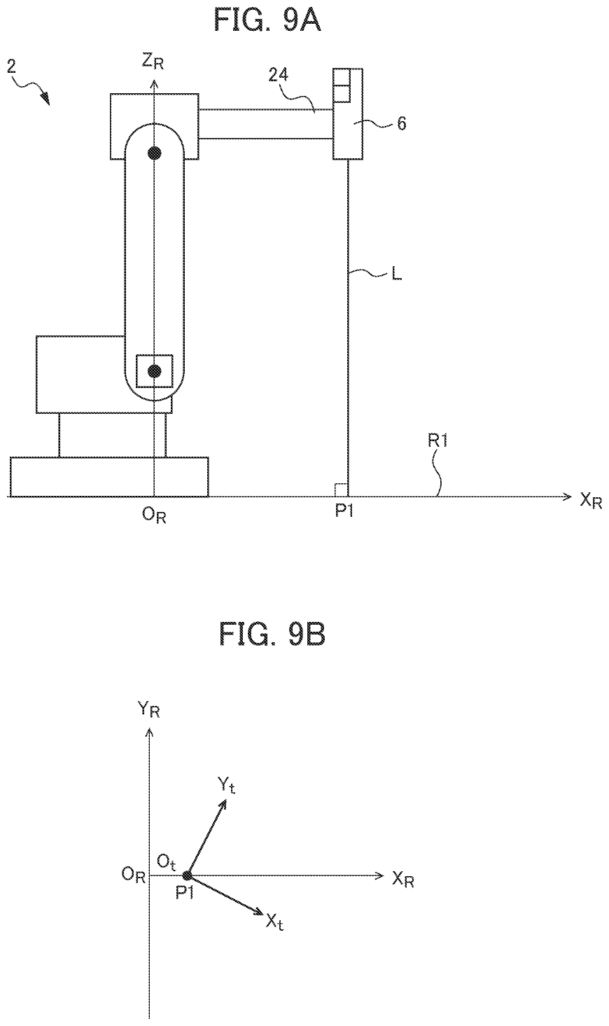

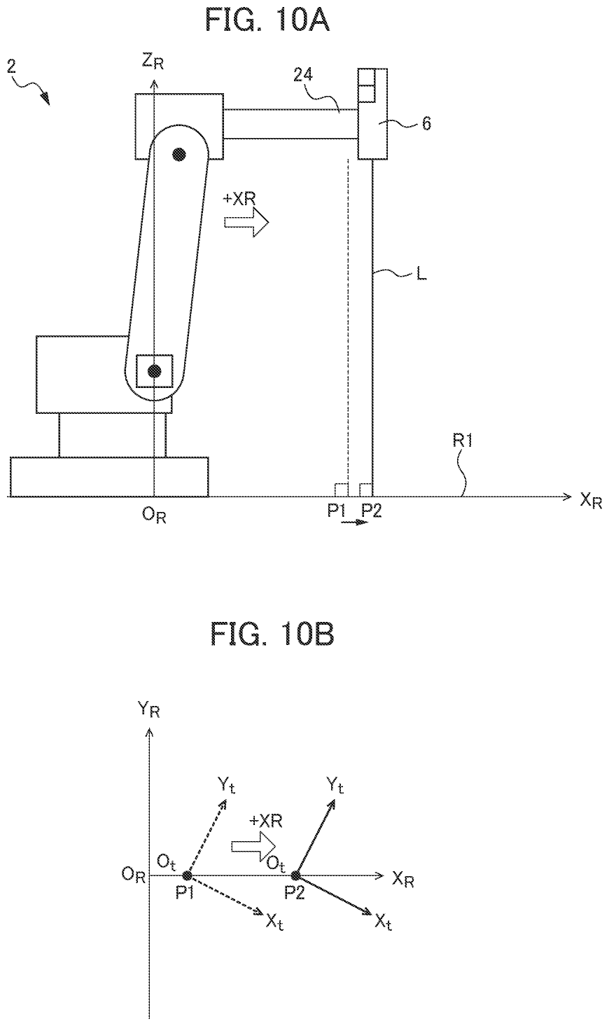

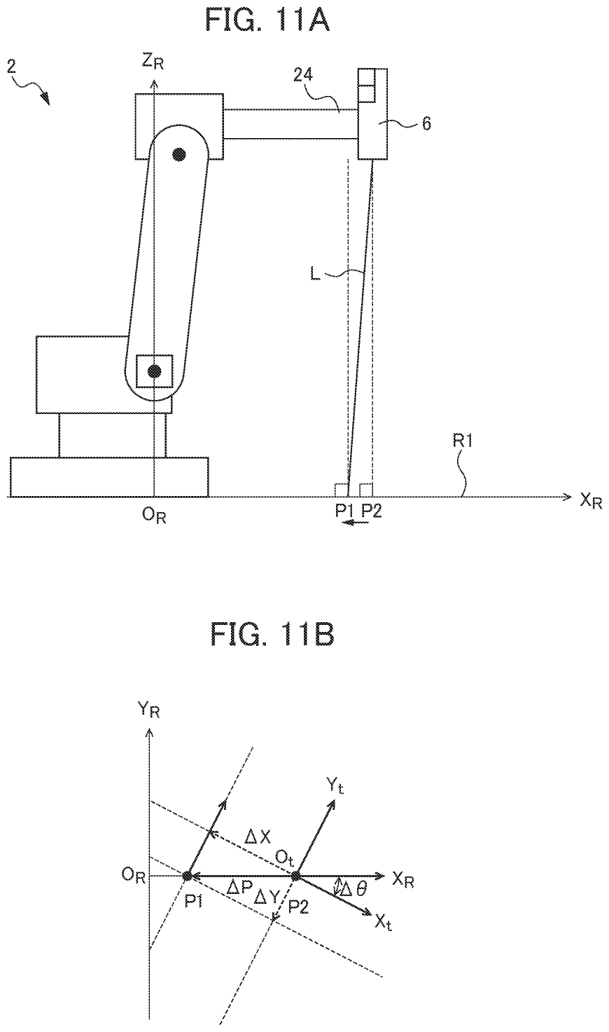

FIG. 8 is a diagram illustrating a principle of the rotary wedge scanner according to the second application example to which the present invention is applied. FIG. 9A is a side view showing one step of a mastering task for the robot system of the second application example. FIG. 9B is a partially enlarged plan view corresponding to FIG. 9A. FIG. 10A is a side view showing a step subsequent to the step shown in FIG. 9A. FIG. 10B is a partially enlarged plan view corresponding to FIG. 10A. FIG. 11A is a side view showing a step subsequent to the step shown in FIG. 10A. FIG. 11B is a partially enlarged plan view corresponding to FIG. 11A.

The rotary wedge scanner (which may also be called, for example, “a trepanning scanner”) as an example of a processing tool can refract an incident laser beam and radiate the laser beam to an arbitrary position by, for example, rotating a lens having one surface being inclined by means of a motor. Specifically, as shown in FIG. 8, in a rotary wedge scanner 6, two prism lenses 61a and 61b (hereinafter, both may be collectively referred to as “prism lenses 61”) and a condenser lens 62 are arranged to overlap with each other so that a laser beam L is incident in a lens thickness direction, and the two prism lenses 61a and 61b rotate around a rotary axis J11. Thereby, a radiation position (a processing position) can be controlled on a two-dimensional plane.

Each of the prism lenses 61 is formed, for example, in a circular shape when viewed in a rotary axis direction. The thickness of each prism lens 61 continuously varies in its circumferential direction. Each prism lens 61 is rotationally driven by the motor (not shown) and is adapted so that the thickness continuously varies along a direction of the rotation.

The laser beam L incident to the prism lens 61 is refracted according to the refractive index of the prism lens 61 and is outputted as a refracted beam. At this time, a beam position of the laser beam L that shifts due to refraction correlates with the thickness of the prism lens 61. That is, as the thickness of the prism lens 61 at an incident position of the laser beam L increases, the shift amount, which is a deviation of the beam position of the laser light L due to refraction, increases. Causing the laser beam L to be transmitted through the prism lens 61 the thickness of which continuously and cyclically varies in the rotation direction makes it possible to continuously and cyclically move the beam position of the laser light L, that is, the radiation position (the processing position) of the laser beam L.

The rotary wedge scanner does not have a mark of a reference direction because of the above-mentioned mechanism of adjusting the phases of the lenses by the motor to control a direction in which an incident laser beam is outputted. Therefore, in the mastering task, a guide laser beam is radiated perpendicularly to a radiation surface and in a focused state, and adjustment is performed while the radiation position is visually checked. First, an origin position is identified by adjusting a relative angle among the lenses, and orthogonal movement direction adjustment is performed eventually. In the orthogonal movement direction adjustment, the radiation position of the guide laser beam is moved in an arbitrary direction from the origin position of the Cartesian coordinate system, and an angle of the movement direction relative to the reference direction is measured and recorded. After the radiation position of the guide laser light is moved to the origin position, the value of the recorded angle is set in the robot controller 41, and the mastering ends.

A specific example will be described below. As shown in FIGS. 9A and 9B, an XR-YR-ZR three-dimensional Cartesian coordinate system (origin: OR) is set as a reference coordinate system for the robot. As a reference coordinate system for the rotary wedge scanner 6, an Xt-Yt Cartesian coordinate system (origin: Ot) is set. A reference plane R1 is parallel to an XR-YR plane and an Xt-Yt plane.

The origin position of the rotary wedge scanner 6 is adjusted. Thereafter, the position and posture of the robot 2 to which the rotary wedge scanner 6 is coupled is moved so that a guide laser beam L is radiated to the flat reference plane R1. This position is stored as a position P1. A mark is attached to the radiation position P1 to which the guide laser beam L is radiated.

As shown in FIGS. 10A and 10B, the robot 2 is moved in an arbitrary direction of the Cartesian coordinate system (for example, in a +XR direction) while the posture of the rotary wedge scanner 6 is maintained. Thereby, the radiation position moves to P2.

As shown in FIGS. 11A and 11B, the radiation position of the guide laser beam L outputted from the rotary wedge scanner 6 is moved to the radiation position P1 while the position and posture of the robot 2 are maintained.

An angle Δθ formed between the reference direction of the robot 2 and the reference direction of the rotary wedge scanner 6 is calculated from a movement amount ΔP of the radiation position of the guide laser beam L. Then, mastering is performed so that the angle Δθ becomes zero, that is, so that both reference directions coincide with each other. In short, reference direction information that is information about the reference direction of the robot 2 is obtained from a movement of the robot 2, and mastering of the rotary wedge scanner 6 as an example of the processing tool is performed based on the obtained reference direction information.

In the second application example, effects similar to those of the first application example are also obtained. Further, even in an environment in which it is difficult for an operator to recognize a reference direction, and dedicated equipment is not provided at the time of maintenance after introduction of an apparatus, and a re-mastering task requires much time and effort, the mastering task can be easily performed.

### Third Application Example

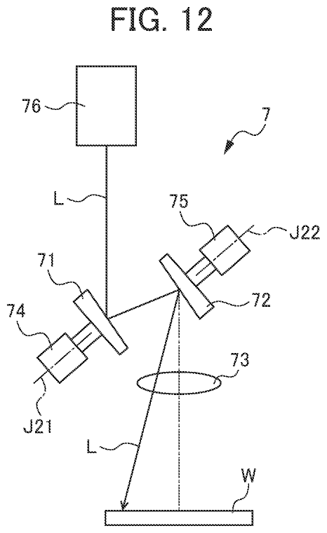

Next, a third application example will be described. The third application example is an example in which the processing tool mastering method of the present invention is applied to a robot system including a robot and a Galvano scanner. FIG. 12 is a diagram illustrating a principle of the Galvano scanner according to the third application example to which the present invention is applied.

As for the third application example, the configuration and principle of the Galvano scanner 7, which is an example of a processing tool, will be briefly described. As shown in FIG. 12, the Galvano scanner 7 is a scanner capable of receiving a laser beam L outputted from a laser oscillator 76 and scanning the laser beam L with respect to a workpiece W. The Galvano scanner 7 is provided with two Galvano mirrors 71 and 72 that reflect the laser beam L outputted from the laser oscillator 76, Galvano motors 74 and 75 that rotationally drive the Galvano mirrors 71 and 72, respectively, and a condenser lens 73. The condenser lens 73 transmits and condenses the laser beam L that is reflected sequentially by the Galvano mirrors 71 and 72 and goes toward the workpiece W.

The Galvano mirrors 71 and 72 are rotatable around two rotary axes J21 and J22 orthogonal to each other, respectively. The Galvano motors 74 and 75 are rotationally driven based on drive data from the tool controller 42 and cause the Galvano mirrors 71 and 72 to independently rotate around the rotary axes J21 and J22.

The laser beam L outputted from the laser oscillator 76 is outputted from the condenser lens 73 of the Galvano scanner 7 after having been reflected sequentially by the two Galvano mirrors 71 and 72, and reaches a machining position (a welding point, a processing position) of the workpiece W. At this time, when the two Galvano mirrors 71 and 72 are rotated by the Galvano motors 74 and 75, respectively, the incident angle of the laser beam L that is incident to the Galvano mirrors 71 and 72 continuously varies. As a result, the laser beam L from the Galvano scanner 7 is scanned in a predetermined path on the workpiece W, and a welding path is formed on the workpiece W along the scanning path of the laser beam L. By appropriately controlling the rotational drive of the Galvano motors 74 and 75 to change the rotation angle of each of the Galvano mirrors 71 and 72, the scanning path of the laser beam L outputted onto the workpiece W from the Galvano scanner 7 can be arbitrarily changed in the X and Y directions. In the third application example, effects similar to those of the second application example are also obtained.

While embodiments of the present invention have been described above, the present invention is not limited to the embodiment described above. Further, the effects described in the embodiments are merely the most favorable effects exerted by the present invention, and the effects of the present invention are not limited to those described in the embodiments.

### EXPLANATION OF REFERENCE NUMERALS

2: Robot
3: Hand arm (processing tool)
6: Rotary wedge scanner (processing tool)
7: Galvano scanner (processing tool)
24: Robot arm distal end part (arm distal end part)

1. A processing tool mastering method for performing mastering of a processing tool that is attached to an arm distal end part of an articulated robot and is configured to perform a predetermined process on a processing target, the articulated robot including a plurality of driving units configured to drive one or more driving axes of the articulated robot, the processing tool mastering method comprising:
controlling the plurality of driving units;
controlling a processing position for the processing tool to perform the process on the processing target; and
obtaining, from a movement of the robot, reference direction information about a reference direction of the robot, so that the mastering of the processing tool is performed based on the obtained reference direction information.
